(19) United States
(12) Patent Application Publication
(10) Pub. No.: US 2026/0085913 A1
(43) Pub. Date: Mar. 26, 2026

(54) ANTI-DRONE EVALUATION SYSTEM AND METHOD

(71) Applicant: ELECTRONICS AND TELECOMMUNICATIONS RESEARCH INSTITUTE, Daejeon (KR)

(72) Inventors: KICHEOUL WANG, Daejeon (KR); Tae Chul HONG, Daejeon (KR)

(73) Assignee: ELECTRONICS AND TELECOMMUNICATIONS RESEARCH INSTITUTE, Daejeon (KR)

(21) Appl. No.: 19/335,967

(22) Filed: Sep. 22, 2025

(30) Foreign Application Priority Data
Sep. 24, 2024 (KR) 10-2024-0129176
Sep. 9, 2025 (KR) 10-2025-0128117

(51) Int. Cl. F41H 11/02; G06V 20/52

(52) U.S. Cl. CPC F41H 11/02; G06V 20/52; G06V 2201/08

(57) ABSTRACT

Disclosed are an anti-drone evaluation system and method. The anti-drone evaluation system includes an anti-drone evaluation server configured to generate and manage an evaluation scenario of an anti-drone product, a ground control station configured to operate in conjunction with the anti-drone evaluation server and configured to establish and transmit a flight plan of an evaluation target vehicle, the evaluation target vehicle configured to copy an illegal drone and to fly under the control of the ground control station, a neutralization photographing target vehicle configured to photograph a neutralization scene upon evaluation of a neutralization function, and an anti-drone product connected to the anti-drone evaluation server and being an evaluation target.

### CROSS-REFERENCE TO RELATED APPLICATION

The present application claims priority to and the benefit of Korean Patent Application Nos. 10-2024-0129176, filed on Sep. 24, 2024, and 10-2025-0128117, filed on Sep. 9, 2025, in the Korean Intellectual Property Office, the entire disclosure of which is incorporated herein by reference.

### BACKGROUND

### 1. Technical Field

The present disclosure relates to an anti-drone evaluation system and method.

### 2. Related Art

Anti-drone evaluation according to a conventional technology has a limit to staying at a level at which the anti-drone evaluation derives a performance evaluation index or suggests a corresponding evaluation system and method by being usually confined to three steps of detection, tracking, and identification functions, among functions performed by an anti-drone product. That is, the anti-drone evaluation according to the conventional technology has a problem in that substantial performance evaluation is performed only partially because the anti-drone evaluation does not include a countermeasure step required for the entire drone threat response system or the comprehensive verification of effects in an actual operation environment.

Furthermore, in the conventional technology, the anti-drone evaluation is performed by the manufacturer of an anti-drone product in order to evaluate the performance of its own product. To this end, information of an evaluation target vehicle and an anti-drone product are input to an evaluation apparatus, and the results of the evaluation are output. In this case, the anti-drone evaluation according to the conventional technology has a problem in that it is difficult to secure the reliability and objectivity of evaluation because the entity that performs the evaluation and the object of the evaluation are the same.

### SUMMARY

Various embodiments are directed to providing a system and method for generating an evaluation scenario for functions for detecting, tracking, identifying, and neutralizing an anti-drone product, performing actual evaluation according to the evaluation scenario, and outputting the results of the evaluation.

An anti-drone evaluation system according to an embodiment of the present disclosure includes an anti-drone evaluation server configured to generate and manage an evaluation scenario of an anti-drone product, a ground control station configured to operate in conjunction with the anti-drone evaluation server and configured to establish and transmit a flight plan of an evaluation target vehicle, the evaluation target vehicle configured to copy an illegal drone and to fly under the control of the ground control station, a neutralization photographing target vehicle configured to photograph a neutralization scene upon evaluation of a neutralization function, and an anti-drone product connected to the anti-drone evaluation server and being an evaluation target.

The anti-drone evaluation server automatically generates the evaluation scenario by using an artificial intelligence model based on evaluation request information.

The ground control station generates a manual flight plan when RF detection is included in the evaluation scenario and generates an automatic flight plan when non-RF detection is included in the evaluation scenario.

Identification Friend or Foe (IFF) devices are connected to the neutralization photographing target vehicle and the anti-drone product, respectively, and identify the neutralization photographing target vehicle so that the anti-drone product does not mistake the neutralization photographing target vehicle for the evaluation target vehicle.

At least one of remote control (RC) communication having a preset band, and Wi-Fi, LTE, and 5G for a mission data exchange is used for communication between the ground control station and the evaluation target vehicle or the neutralization photographing target vehicle.

The anti-drone evaluation server prepares a result report after completion of the evaluation, transmits the result report to an evaluation request company, and performs training relating to the generation of a scenario by using a pair of evaluation request contents and evaluation result.

An anti-drone evaluation method according to an embodiment of the present disclosure includes steps of (a) receiving an evaluation request from a company of an anti-drone product, generating an evaluation scenario, and determining the evaluation scenario through consultation with the company of the anti-drone product, (b) transmitting the determined evaluation scenario to a ground control station and establishing a flight plan, (c) connecting the anti-drone product, an anti-drone evaluation server, the ground control station, and an evaluation target vehicle and performing time synchronization and an interoperability testing, (d) making the evaluation target vehicle fly according to the determined evaluation scenario and causing the anti-drone product to perform detection, tracking, identification, and neutralization functions of the anti-drone product, (e) receiving target information from the anti-drone product, receiving ground truth data from the ground control station, and performing evaluation on performance of the anti-drone product, and (f) preparing a result report based on the target information and the ground truth data.

The evaluation scenerio includes product-related information, evaluation target vehicle-related information (including at least any one of a number, form, size, flight pattern, and flight method of the evaluation target vehicle), evaluation items, a target information-providing source, and evaluation metrics.

The step (b) includes generating an automatic or manual flight plan depending on whether RF detection is included in the evaluation scenario.

When hard kill is included in the evaluation scenario, the step (e) includes receiving ground truth data for the hard kill from a neutralization photographing target vehicle.

The anti-drone evaluation method according to an embodiment of the present disclosure further includes a step of (g) performing AI training relating to a generation of a scenario by using a pair of evaluation request contents and evaluation result.

An anti-drone evaluation server according to an embodiment of the present disclosure includes an evaluation scenario generation unit configured to generate an evaluation scenario based on evaluation request information, a detection function evaluation unit configured to evaluate a detection function of an anti-drone product, a tracking function evaluation unit configured to evaluate a tracking function of the anti-drone product, an identification function evaluation unit configured to evaluate an identification function of the anti-drone product, a neutralization function evaluation unit configured to evaluate a neutralization function of the anti-drone product, and a determination unit configured to write evaluation results of the anti-drone product.

The detection function evaluation unit receives different target information depending on radar detection or RF detection.

The neutralization function evaluation unit evaluates neutralization performance by comparing information received from the anti-drone product and information received from a neutralization photographing target vehicle.

The anti-drone evaluation server according to an embodiment of the present disclosure further includes a repository in which evaluation request contents and evaluation result are stored.

The anti-drone evaluation server according to an embodiment of the present disclosure further includes an AI training unit configured to perform a training of an artificial intelligence model for a generation of an evaluation scenario by using the evaluation request contents and the evaluation result stored in the repository.

The AI training unit uploads the trained artificial intelligence model to the evaluation scenario generation unit.

According to a conventional technology, only functions for detecting, tracking, and identifying an anti-drone product are evaluated, and a neutralization function, that is, a substantial handling function, is not specified as an evaluation item or a procedure or structure for verifying the neutralization function in an actual environment is not specifically proposed. In contrast, according to embodiments of the present disclosure, it is possible to overcome the limit of an evaluation range and to verify the maturity and effectiveness of an anti-drone technology in an actual environment because the system and method capable of evaluating all of the functions (e.g., detection, tracking, identification, and neutralization) of an anti-drone product are provided.

According to an embodiment of the present disclosure, there is an effect in that it is possible to secure the reliability and objectivity of evaluation results because an independent subject for evaluation, which is not related to a manufacturer of an anti-drone product, operates a system.

According to an embodiment of the present disclosure, it is possible to reduce an evaluation error by repeatedly performing evaluation for the number of scenarios that is agreed upon a manufacturer of an anti-drone product, and deriving final evaluation results by analyzing evaluation request contents of a corresponding product and actual evaluation results.

According to an embodiment of the present disclosure, there is provided an intelligent evaluation environment capable of automatically generating an evaluation scenario for a future new product by storing an evaluation request contents and final evaluation results pair after the evaluation of an anti-drone product is terminated and periodically performing AI training based on the stored evaluation request contents and final evaluation results pair. Such an AI-based scenario generation function has an advantage in that it continuously improves efficiency and accuracy of evaluation.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 illustrates an environment for evaluating an anti-drone product according to an embodiment of the present disclosure.

FIG. 2 illustrates an anti-drone evaluation system according to an embodiment of the present disclosure.

FIG. 3 illustrates an anti-drone product evaluation execution procedure according to an embodiment of the present disclosure.

FIG. 4 illustrates an anti-drone product evaluation request and evaluation scenario determination process according to an embodiment of the present disclosure.

FIG. 5 illustrates a process of transmitting a scenario, generating a flight plan, and transmitting the flight plan according to an embodiment of the present disclosure.

FIG. 6 illustrates a process of connecting an anti-drone product and an anti-drone evaluation system and performing time synchronization and an interoperability test according to an embodiment of the present disclosure.

FIG. 7 illustrates an anti-drone product evaluation process according to an embodiment of the present disclosure.

FIG. 8 illustrates a process of analyzing the results of evaluation after the evaluation of an anti-drone product is completed, writing a final evaluation result report, and transmitting the report to a manufacturer of the anti-drone product according to an embodiment of the present disclosure.

FIG. 9 illustrates a procedure of performing AI training on the evaluation request contents and final evaluation results of an anti-drone product after the final evaluation of the anti-drone product is terminated according to an embodiment of the present disclosure.

FIG. 10 is a block diagram illustrating a computer system for implementing a method according to an embodiment of the present disclosure.

### DETAILED DESCRIPTION

The aforementioned object, other objects, advantages, characteristics of the present disclosure, and a method for achieving the objects will become clear with reference to embodiments to be described in detail along with the accompanying drawings.

However, the present disclosure is not limited to embodiments disclosed hereinafter, but may be implemented in various different forms. The following embodiments are merely provided to enable a person having ordinary knowledge in the art understand the objects, structures, and advantages of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

In order to help understanding of those skilled in the art, hereinafter, a proposed background of the present disclosure is described and embodiments of the present disclosure are then described.

According to a conventional technology, there has been proposed a procedure and method for evaluating performance of an anti-drone product, including the detection, tracking, and identification functions. In general, such techniques have suggested some metrics and an evaluation flow for verifying performance of each function of an anti-drone system that is developed to prevent the infiltration of an illegal drone.

Furthermore, there is a technique that suggests a system component, evaluation metrics, and a system structure for evaluating the aforementioned functions. For example, an evaluation platform has been proposed comprising a sensor-based detection device, an image-based identification device, and a communication interface.

According to a conventional technology, a company that manufactures an anti-drone product has proposed an evaluation method and system for autonomously measuring performance of its product. A performance evaluation apparatus is included in such a system and can output evaluation results. After information on a drone (hereinafter referred to as an “evaluation target vehicle”), that is, an anti-drone evaluation target, and an anti-drone product are input to a performance evaluation apparatus, the evaluation target vehicle is actually made to fly, the ability of anti-drone product to detect and track the evaluation target vehicle is tested, and test report is generated and output.

Furthermore, the detection, identification, and neutralization functions are provided as an integrated system. In particular, in order to increase the accuracy of neutralization, there is provided a technique that excludes an evaluation target vehicle from neutralization upon determining that the evaluation target vehicle is not a neutralization target. This reduces false alarms and the likelihood of erroneous engagement of a non-threatening drone, and is advantageous in reducing error rates in real military operational environments.

Furthermore, in order to handle a complicated scenario in which a plurality of illegal drones simultaneously appears, there has been provided a technique that performs more strategic neutralization by identifying the ID of each drone, setting the priority of each drone, and obtaining additional information of the identified drones.

Anti-drone evaluation according to a conventional technology proposes an evaluation method and procedure after deriving metrics for evaluating performance for detection, tracking, and identification steps, among functions performed by an anti-drone product, and constructing an evaluation system based on metrics. For example, such an evaluation technique merely proposes a system structure and procedure that are designed to evaluate corresponding functions based on widely known metrics (e.g., a detection distance, tracking accuracy, and an identification rate).

In contrast, embodiments of the present disclosure propose a system capable of integrally performing quantitative and qualitative performance evaluation on all functions, that is, detection, tracking, identification, and the countermeasure step, and specifically propose an evaluation method using the system.

Furthermore, a conventional technology proposes a system configuration for autonomously evaluating, by a manufacturer of an anti-drone product, performance of its product, and proposes a structure in which information of an evaluation target vehicle and an anti-drone product is input to an evaluation apparatus through an evaluation system including the anti-drone product, the evaluation target vehicle, and a performance evaluation apparatus, for example, and evaluation is performed through an actual drone flight, and the results of the evaluation are output. However, such self-evaluation has a limit to securing the reliability and objectivity of evaluation because the self-evaluation is performed in a situation in which a subject for evaluation execution is identical with an evaluation target or has an interest in the evaluation target.

In contrast, embodiment of the present disclosure provides an objective and standardized evaluation system in which an independent evaluation institution or third operating entity not having an interest in a manufacturer of an anti-drone product performs evaluation. Furthermore, embodiment of the present disclosure proposes a scenario-based evaluation procedure and methodology designed to enable comprehensive evaluation of all of function steps (e.g., detection, tracking, identification, and neutralization) of an anti-drone product, and can contribute to the substantial performance comparison of an anti-drone technology and the establishment of a certification system.

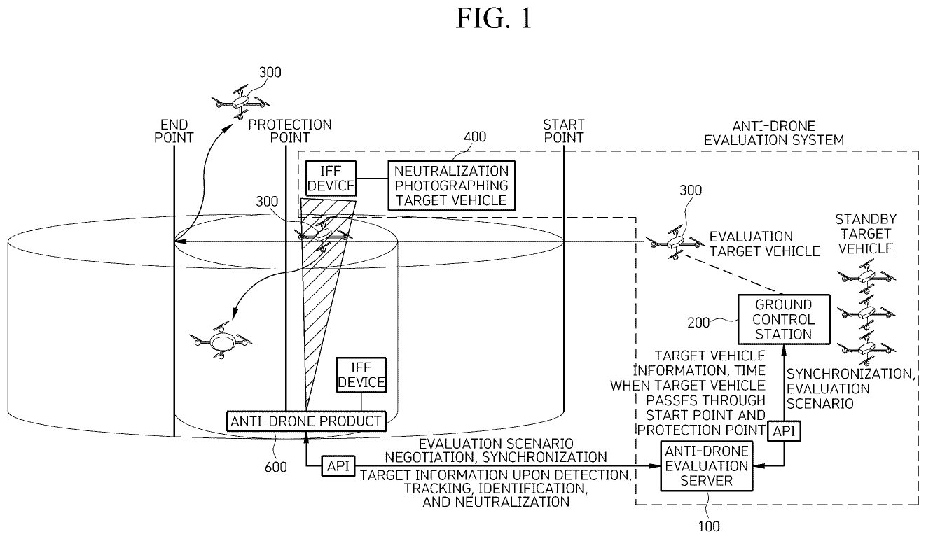

FIG. 1 illustrates an environment for evaluating an anti-drone product according to an embodiment of the present disclosure.

An evaluation environment for an anti-drone product according to an embodiment of the present disclosure basically includes three elements, that is, an anti-drone product that is an evaluation target, an anti-drone evaluation system as the subject of evaluation, and an anti-drone evaluation test site that is a place where actual evaluation is performed.

The anti-drone evaluation system includes an evaluation target vehicle 300 that is operated to copy a threat situation of an illegal drone, a neutralization photographing target vehicle 400 that photographs and records a hard kill execution scene of an anti-drone product 600 that is an evaluation target vehicle, a ground control station 200 that manages and operates a plurality of evaluation target vehicles in real time, and an anti-drone evaluation server 100 that comprehensively measures and analyzes detection, tracking, identification, and neutralization performance of the anti-drone product 600.

Furthermore, a plurality of specific points is set in the anti-drone evaluation test site. The plurality of specific points is defined as a start point, a protection point, and an end point. In this case, the protection point refers to a location at which a simulated critical facility or a person to be protected from an illegal drone is located. In general, the start point is set at a location of about 5 km of the radius from the protection point. The end point is set at a location within about 50 m of the radius from the protection point. Such point setting enables performance of the anti-drone product to be objectively evaluated under a practical operation environment because an actual penetration scenario in which an illegal drone starts from a remote distance and approaches near a target point is copied.

The evaluation target vehicle starts to fly from the outskirts of a test site, sequentially passes through a set start point and protection point, and then flies up to an end point. The ground control station collect data, such as a model name of the evaluation target vehicle, information (e.g., latitude, longitude, and altitude) on the location of the evaluation target vehicle, distance to the anti-drone product, flight direction, and flight time in real time, and transmits the data to the anti-drone evaluation server. Furthermore, the ground control station immediately transmits time information of a time point at which the evaluation target vehicle passes through the start point and the protection point to the anti-drone evaluation server so that the anti-drone evaluation server uses the time information to evaluate detection, tracking, and identification performance of the anti-drone product.

The evaluation target vehicle that has finished flight is set to pass through the end point, fall outside the test site area, and return to the initial departure point. Such flight of the evaluation target vehicle is not terminated on a one off basis, but may be performed repeatedly under the same scenario or modified conditions. The type and flight altitude of the evaluation target vehicle may be changed variously for each flight time. Furthermore, the flight path of the evaluation target vehicle is not essentially limited to a straight form, and may include curved flight, evasion flight, and an altitude change. Such detailed flight conditions are determined by consultation between a manufacturer and an evaluation institution before the evaluation of the anti-drone product is started.

Furthermore, a scenario in which a plurality of evaluation target vehicles simultaneously flies, in addition to a scenario in which a single evaluation target vehicle flies, may be set. Even in such a case, an evaluation condition and a detailed procedure are determined through consultation between a manufacturer and an evaluation institution. In particular, when the hard kill function of the anti-drone product is evaluated, in order to objectively identify whether the evaluation target vehicle has been actual neutralized, the neutralization photographing target vehicle is operated. That is, at a time point at which the anti-drone product performs hard kill on the evaluation target vehicle, the neutralization photographing target vehicle transmits a neutralization image and time information to the ground control station. The ground control station transmits the neutralization image and time information to the anti-drone evaluation server so that neutralization performance can be quantitatively recorded and evaluated.

In order to prevent the neutralization photographing target vehicle itself from being mistaken for an attack target of the anti-drone product, an identification friend or foe (IFF) device is attached to each of the anti-drone product and the neutralization photographing target vehicle. Accordingly, the neutralization photographing target vehicle may safely perform a mission in an evaluation process through the IFF device. The neutralization photographing target vehicle is constructed from impact-absorbing materials to withstand fragments generated during neutralization, and is equipped with a multi-axis gimbal to ensure the safe capture of the neutralization scene.

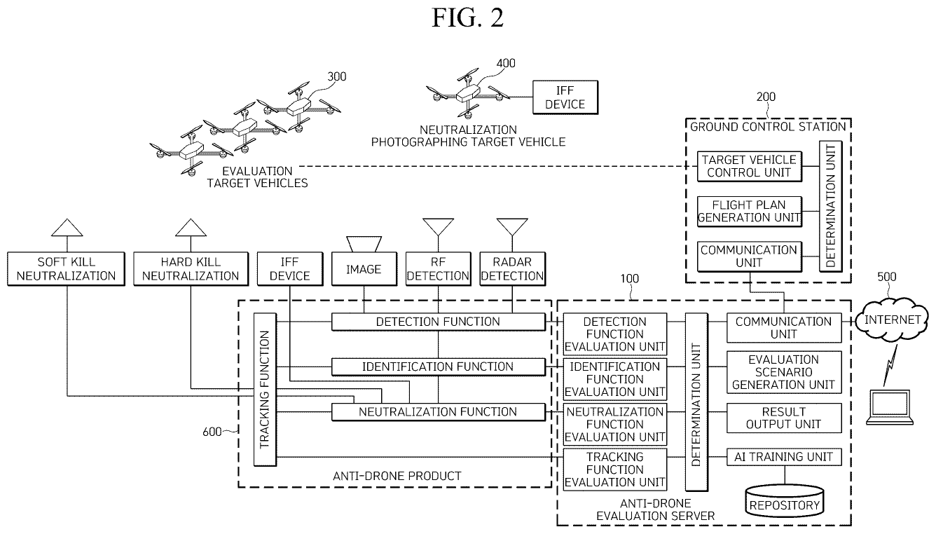

FIG. 2 illustrates an anti-drone evaluation system according to an embodiment of the present disclosure.

FIG. 2 illustrates a construction of the anti-drone evaluation system for performing performance evaluation of the anti-drone product in the evaluation environment illustrated in FIG. 1.

The anti-drone evaluation system includes the anti-drone evaluation server 100, the ground control station 200, the evaluation target vehicle 300, and the neutralization photographing target vehicle 400. Furthermore, the anti-drone product 600, that is, a performance evaluation target, is connected to the anti-drone evaluation server 100. Performance of the anti-drone product 600, such as detection, tracking, identification, and neutralization, is systematically evaluated according to a set evaluation scenario.

The company of the anti-drone product 600 may request an operator of the anti-drone evaluation server 100 to evaluate the anti-drone product 600 over a network, for example(e.g. the Internet 500). Evaluation request information metadata may include: (i)product operation environments (e.g., an open area, a mountainous area, a nuclear power plant area, a urban area, and a military operational area); (ii)the product name; (iii) a detailed construction; (iv)technical specifications; (v)evaluation requester; and (vii) a point of contact.

After receiving the evaluation request information, the operator of the anti-drone evaluation server 100 provides a control instruction to an internal evaluation scenario generation unit so that various evaluation scenarios are generated. The generated evaluation scenarios include the type, flight pattern, and altitude of the evaluation target vehicle, whether multiple evaluation target vehicles operate simultaneously, evaluation steps (e.g., detection, tracking, identification, and neutralization), and recording and analysis conditions are designed to measure performance of the anti-drone product 600 objectively and reproducibly.

An AI model that is loaded onto the evaluation scenario generation unit automatically generates optimal evaluation scenarios into which characteristics and required performance of a corresponding product have been incorporated based on evaluation request information provided by a company of the anti-drone product. The generated evaluation scenario includes evaluation product-related information (e.g., a product name, a product construction, and a function module), evaluation target vehicle-related information (e.g., the number, form, size, flight pattern, and flight method of the evaluation target vehicle), evaluation item-related information (e.g., detection, tracking, identification, and neutralization), target information-providing source (e.g., a target's location, the target's direction, and the target's speed), evaluation metrics (e.g., success ratio of detection, tracking, identification, and neutralization, latency, a false positive rate, and a false negative rate).

After first generated, the scenarios may be repeatedly modified and supplemented until an agreement between the company and an evaluation institution is made. Scenarios that have been finally determined are transmitted from the anti-drone evaluation server 100 to the ground control station 200.

The ground control station 200 generates an automatic flight plan or a manual flight plan in accordance with each evaluation scenario. The generated automatic flight plan is uploaded to the evaluation target vehicle 300 and autonomously executed. The manual flight plan is assigned to a designated pilot and transmitted to that pilot. For example, when the performance of an anti-drone product including an RF detection device is evaluated, because the product must detect the RF signals of the evaluation target vehicle and intentionally distort or interfere with those signals, the evaluation target vehicles are planned to be flown manually. In contrast, with respect to evaluation items not related to an RF signal, automatic flight plans for the evaluation target vehicles are established so that the evaluation target vehicles perform automatic flight.

Furthermore, if hard kill items are included in the evaluation scenario, the ground control station 200 writes a manual flight plan in a form in which the neutralization photographing target vehicle 400 starts to fly at a relatively higher altitude than the evaluation target vehicle 300 and follows the evaluation target vehicle up to the end point of the evaluation target vehicle. The written flight plan of the neutralization photographing target vehicle is delivered to the designated pilot.

In this case, in the neutralization evaluation process, to prevent the anti-drone product from mistaking the neutralization photographing target vehicle itself for an attack target, the Identification Friend or Foe (IFF) devices are attached to the neutralization photographing target vehicle and the anti-drone product before evaluation begins. The IFF devices exchange signals to ensure that the anti-drone product does not mistake the neutralization photographing target vehicle for a target. Accordingly, the neutralization scene can be accurately recorded during the evaluation process. Furthermore, the neutralization photographing target vehicle uses the multi-axis gimbal in order to guarantee the stability of neutralization scene photographing, and is constructed from impact-=absorbing materials to reduce impacts from fragments generated during neutralization.

The anti-drone evaluation server 100 internally includes a detection function evaluation unit, a tracking function evaluation unit, an identification function evaluation unit, and a neutralization function evaluation unit in order to independently evaluate the detection function, identification function, tracking function, and the neutralization function of the anti-drone product 600.

In an evaluation process, the anti-drone evaluation server 100 receives target information that is obtained when performing detection, tracking, identification, and neutralization from the anti-drone product 600, and simultaneously receives ground truth data from the ground control station 200. Thereafter, a determination unit within the anti-drone evaluation server 100 performs performance evaluation on each of the functions of the anti-drone product 600 by comparing and analyzing the received target information and the received ground truth data.

### 1. Evaluation of Detection Function

The detection function that is performed by the anti-drone product 600 provides different data depending on the type of sensor used.

In the case of radar detection, {location (latitude, longitude, and altitude), distance, direction, time} information is transmitted to the detection function evaluation unit.

In the case of RF detection, {drone location (latitude, longitude, altitude), drone home location (latitude, longitude, altitude), pilot location (latitude, longitude), direction, model name, time} information is transmitted to the detection function evaluation unit.

The ground control station 200 transmits {model name, location, distance to the anti-drone product, direction, time} information of the evaluation target vehicle 300 to the anti-drone evaluation server in real time. In the case of RF detection, information on the home location of a drone and a pilot's location is also additionally provided to the anti-drone evaluation server. Accordingly, the detection function of the anti-drone product 600 is evaluated by comparing the target information from the anti-drone product with the ground truth data from the ground control station.

### 2. Evaluation of Identification and Tracking Functions

The identification function of the anti-drone product 600 transmits {location, direction, target image, time} information of the evaluation target vehicle to the identification function evaluation unit of the anti-drone evaluation server 100. The tracking function of the anti-drone product 600 also transmits data having the same form to the tracking function evaluation unit of the anti-drone evaluation server 100.

The {location, direction, target image, time} information is compared with real-time ground truth data of the evaluation target vehicle, which is provided by the ground control station 200, in order to evaluate identification accuracy and tracking consistency.

### 3. Evaluation of Soft Kill Function

The soft kill function of the anti-drone product 600 is performed based on target information obtained from a detection device.

In the case of RF detection-based soft kill, {drone location, drone home location, pilot location, direction, model name, time} information is transmitted to the neutralization function evaluation unit.

In the case of radar detection-based soft kill, {location, distance, direction, time} information is transmitted to the neutralization function evaluation unit.

At the same time, the ground control station 200 provides {model name, location, distance to the anti-drone product, direction, time} information of the evaluation target vehicle in real time. In the case of RF detection, even drone home location and pilot location information is additionally provided so that performance of the soft kill function can be objectively verified.

### 4. Evaluation of Hard Kill Function

The hard kill function module of the anti-drone product 600 transmits {target destruction image and time} information to the neutralization function evaluation unit. The neutralization function evaluation unit evaluates actual neutralization performance by comparing and verifying {neutralization image, time} data received from the neutralization photographing target vehicle 400.

The IFF devices are mounted on both the anti-drone product 600 and the neutralization photographing target vehicle 400 and perform the exchange of signals. It is guaranteed that the anti-drone product does not perform a hard kill operation on the neutralization photographing target vehicle by mistaking the neutralization photographing target vehicle for an attack target through the IFF devices.

### 5. Processing of Final Evaluation Results and AI Training

After the evaluation of the anti-drone product 600 is terminated, an operator of the anti-drone evaluation server 100 generates final evaluation results by analyzing collected evaluation data. A report on the generated final evaluation results is provided to the company of the anti-drone product. At the same time, a pair {evaluation request contents, final evaluation result} of the anti-drone product is recorded on the repository of the anti-drone evaluation server.

The stored data is used to periodically train an AI model. Accordingly, the AI model of the evaluation scenario generation unit is gradually advanced. As a result, the evaluation system has a self-evolving characteristic in which a customized scenario suitable for various product groups and operation environments can be automatically generated.

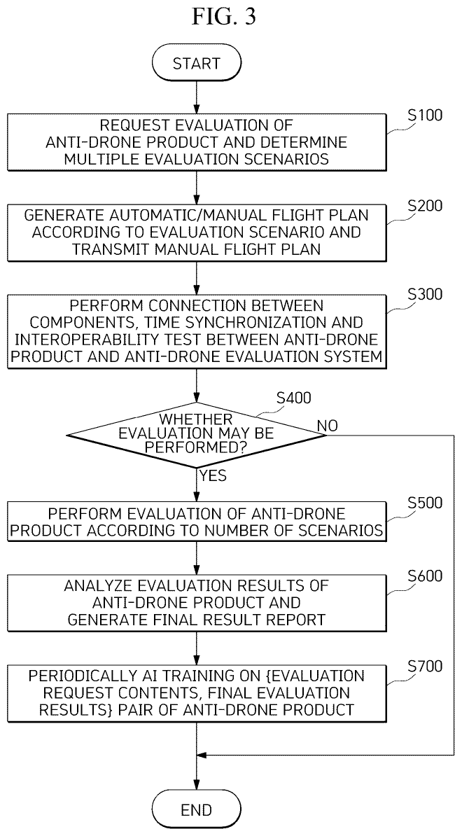

FIG. 3 illustrates an anti-drone product evaluation execution procedure according to an embodiment of the present disclosure.

In step S100, the company of an anti-drone product submits an evaluation request for the anti-drone product through the Internet. An operator of the anti-drone evaluation server 100 generates evaluation scenarios into which characteristics and required performance of the anti-drone product have been incorporated based on the contents of the received evaluation request. The generated evaluation scenarios are transmitted to the company of the anti-drone product and are modified and supplemented based on the company's feedback. A final evaluation scenario is determined through a mutual agreement. The determined scenario is transmitted to the company.

In step S200, the anti-drone evaluation server 100 transmits the determined evaluation scenario to the ground control station 200. The ground control station 200 generates an automatic or manual flight plan according to the scenario. The generated manual flight plan is transmitted to a designated pilot. Accordingly, the preparation of operations of the evaluation target vehicle 300 and the neutralization photographing target vehicle 400 is completed.

In step S300, connection between components, time synchronization, and an interoperability test between the anti-drone product 600 and the anti-drone evaluation system are performed. The results of the interoperability test are analyzed by the anti-drone evaluation server 100.

In step S400, whether evaluation may be performed is determined. When it is determined that the evaluation can be performed, in step S500, an actual evaluation procedure is performed the agreed number of times. In contrast, when the execution of the evaluation is impossible, the procedure is terminated.

When actual evaluation is terminated, in step S600, the anti-drone evaluation server prepares a final evaluation result report by aggregating the collected evaluation data, and transmits the report on the evaluation request company. Furthermore, a pair {evaluation request contents, final result} of the anti-drone product is recorded on the repository of the anti-drone evaluation server 100.

In step S700, the anti-drone evaluation server periodically performs AI training by invoking the {evaluation request contents, final evaluation results} pairs accumulated in the repository. The trained AI model is loaded onto the evaluation scenario generation unit again. Accordingly, the anti-drone evaluation system is gradually advanced so that a more sophisticated and optimized evaluation scenario can be automatically generated with respect to a subsequent request.

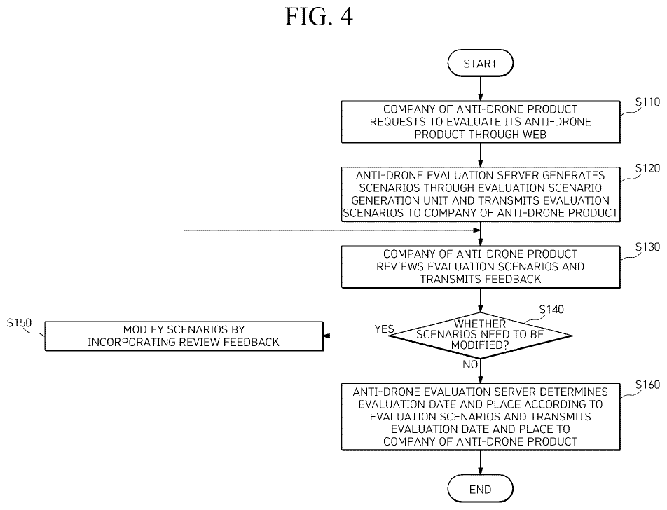

FIG. 4 illustrates the anti-drone product evaluation request and evaluation scenario determination process (step S100 of the anti-drone product execution evaluation procedure illustrated in FIG. 3) according to an embodiment of the present disclosure.

In step S110, a company of an anti-drone product requests to evaluate the anti-drone product through the Internet.

In step S120, an operator of the anti-drone evaluation server generates evaluation scenarios through the evaluation scenario generation unit, and transmits the evaluation scenarios to the company of the anti-drone product. The evaluation scenarios may include contents related to an evaluation product (e.g., a product name and a product construction), contents related to the evaluation target vehicle (e.g., a quantity, a size, and a flight method), contents related to evaluation items (e.g., detection, tracking, identification, and neutralization), contents related to a target information-providing source, evaluation indices (e.g., the success ratio of detection/tracking/identification/neutralization, latency, a false positive rate, and a false negative rate) .

In step S130, the company of the anti-drone product reviews the evaluation scenarios and transmits feedback on the review to the anti-drone evaluation server as a response.

In step S140, the anti-drone evaluation server reviews whether the scenarios need to be modified. When determining that the scenarios need to be modified, the anti-drone evaluation server modifies the scenarios by incorporating the review feedback in step S150.

When determining that the scenarios do not need to be additionally modified, in step S160, the operator of the anti-drone evaluation server determines an evaluation date and place according to the evaluation scenarios and transmits the evaluation date and place to the company of the anti-drone product.

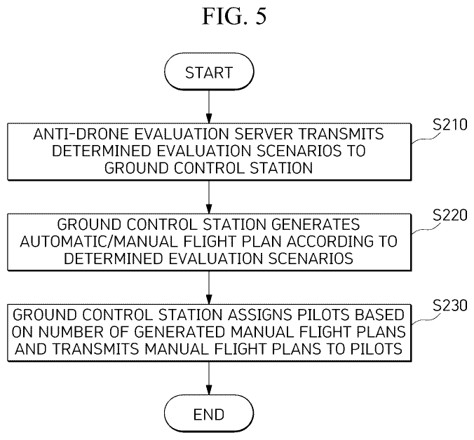

FIG. 5 illustrates the process (step S200 of the anti-drone product execution evaluation procedure illustrated in FIG. 3) of transmitting the scenarios, generating the flight plan, and transmitting the flight plan according to an embodiment of the present disclosure.

In step S210, the anti-drone evaluation server transmits the determined evaluation scenarios to the ground control station.

In step S220, the ground control station generates an automatic or manual flight plan for the evaluation target vehicles based on conditions for the received evaluation scenario.

If an arbitrary evaluation scenario includes performance evaluation of an RF detection device, a flight plan according to manual control is essential because RF signal characteristics of the evaluation target vehicle directly affect RF-based detection results. Accordingly, if an evaluation scenario is an RF detection evaluation scenario including n evaluation target vehicles, n manual flight plans corresponding to the n evaluation target vehicles, respectively, are written.

In contrast, if a specific evaluation scenario includes the evaluation of a non-RF-based detection function (e.g., radar detection), the ground control station generates and sets automatic flight plans corresponding to the number of evaluation target vehicles so that the automatic flight plans are operated.

If the evaluation of the hard kill function is included in the evaluation scenario, the ground control station additionally generates a manual flight plan for the neutralization photographing target vehicle in order to accurately record a neutralization scene. In this case, the flight of the neutralization photographing target vehicle is performed at a higher altitude than the evaluation target vehicle. In this case, masterful control of a pilot is required in order to secure photographing stability.

In step S230, the ground control station assigns required pilots based on the number of generated manual flight plans, and transmits a corresponding manual flight plan to each of the pilots. Accordingly, all of the evaluation target vehicles and the neutralization photographing target vehicles are prepared based on the determined evaluation scenario.

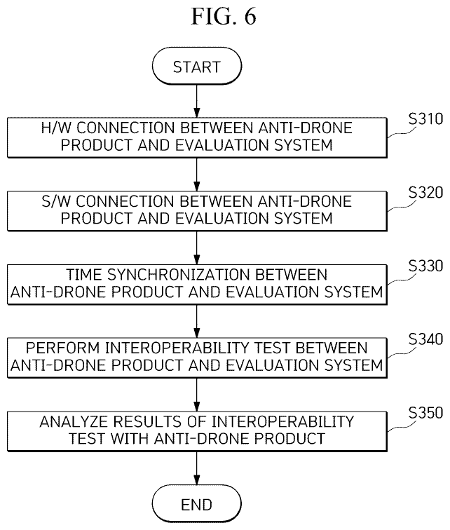

FIG. 6 illustrates the process (step S300 of the anti-drone product execution evaluation procedure illustrated in FIG. 3) of connecting the anti-drone product and the anti-drone evaluation system and performing the time synchronization and interoperability test according to an embodiment of the present disclosure.

In step S310, the anti-drone product, the anti-drone evaluation server, the ground control station, and the evaluation target vehicles are hardware-connected. In this case, the connection between the anti-drone product and the anti-drone evaluation server and the connection between the anti-drone evaluation server and the ground control station may be performed by using various wire and wireless communication methods, such as Ethernet, Wi-Fi, C band communication, long term evolution (LTE), and 5G communication.

The connection between the ground control station and the evaluation target vehicles is distinguished according to its purpose. For the exchange of a control instruction and state information, remote control (RC) communication using a 400 MHz band or a 900 MHz band may be used. For the exchange of mission data (e.g., a flight log and image data), high-speed data communication methods, such as Wi-Fi, LTE, and 5G, may be applied.

In step S320, the anti-drone product, the anti-drone evaluation server, the ground control station, and the evaluation target vehicles are connected in a software manner, and are set so that data formats, and communication protocols and interfaces are mutually compatible.

In step S330, the anti-drone evaluation server performs time synchronization with the anti-drone product, the ground control station, and the evaluation target vehicles. The time synchronization enables the individual devices to share the same time reference so that the individual devices can analyze the results of detection, tracking, identification, and neutralization by accurately making the results correspond to each other on a time axis.

In step S340, the anti-drone evaluation server verifies whether data transmission and reception and the execution of instructions between components are performed normally by performing an interoperability test with the anti-drone product, the ground control station, and the evaluation target vehicles.

When the interoperability test is completed, in step S350, the anti-drone evaluation server finally confirms whether an evaluation procedure has been prepared to be performed by analyzing the results of the interoperability test collected from the anti-drone product.

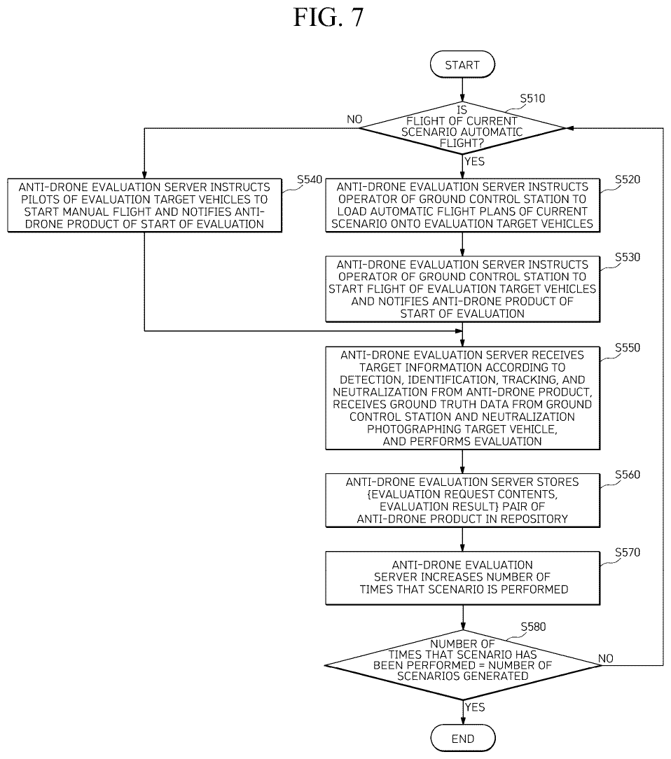

FIG. 7 illustrates the anti-drone product evaluation process (step S500 of the anti-drone product execution evaluation procedure illustrated in FIG. 3) according to an embodiment of the present disclosure.

In step S510, the anti-drone evaluation server determines whether a flight method of a current scenario is automatic flight.

When determining that the flight method of the current scenario is the automatic flight, the anti-drone evaluation server instructs the ground control station to load an automatic flight plan onto the evaluation target vehicles in step S520. Next, in step S530, the anti-drone evaluation server instructs the ground control station to start the flight of the evaluation target vehicles and notifies the anti-drone product of the start of evaluation.

When determining that the flight method of the current scenario is a manual flight in step S510, the anti-drone evaluation server instructs the pilots of the evaluation target vehicles to start the manual flight and simultaneously notifies the anti-drone product of the start of evaluation in step S540.

The evaluation target vehicles perform the automatic flight based on the automatic flight plans or the manual flight by the pilots. In the case of an anti-drone product on which RF detection equipment is mounted, performance of the detection function can be verified only when a pilot manually pilots the evaluation target vehicle in order to recognize an RF signal. In contrast, in the case of a product not including RF detection equipment, the evaluation target vehicles fly according to automatic flight plans that are previously mounted on the evaluation target vehicles. Furthermore, if the hard kill function is included in evaluation, the neutralization photographing target vehicle records a neutralization scene by starting manual flight after the flight of the evaluation target vehicle.

In step S550, the anti-drone evaluation server receives target information obtained when detection, tracking, identification, and neutralization are performed from the anti-drone product, and simultaneously receives ground truth data of the evaluation target vehicle from the ground control station.

Detailed examples of the target information that are transmitted from the anti-drone product to the anti-drone evaluation server are as follows. Upon evaluation of the detection function, in the case of radar detection, {location (latitude, longitude, altitude), distance, direction, time} information is transmitted to the detection function evaluation unit. In the case of RF detection, {drone location, drone home location, pilot location, direction, model name, time} information is transmitted to the detection function evaluation unit of the anti-drone evaluation server. Upon evaluation of the identification function, {location, direction, target image, time} information of the evaluation target vehicle is transmitted to the identification function evaluation unit of the anti-drone evaluation server. Upon evaluation of the tracking function, {location, direction, target image, time} information of the evaluation target vehicle is transmitted to the tracking function evaluation unit of the anti-drone evaluation server.

The ground control station transmits {model name, location (latitude, longitude, altitude), distance to the anti-drone product, direction, time } of the evaluation target vehicle to the anti-drone evaluation server in real time. Accordingly, the detection, tracking, and identification functions of the anti-drone product are easily evaluated. In the case of RF detection, the ground control station additionally transmits the home location (latitude, longitude, altitude) of the evaluation target vehicle and the location (latitude, longitude) of a pilot to the anti-drone evaluation server, thereby improving the accuracy of evaluation.

In the case of RF detection, the ground control station additionally transmits the home location (latitude, longitude, and altitude) of the evaluation target vehicle and the location (latitude and longitude) of a pilot to the anti-drone evaluation server in order to increase the accuracy of evaluation.

The soft kill function module of the anti-drone product obtains target information by using the detection devices. In this case, when receiving the target information through RF detection, the soft kill function module transmits {location (latitude, longitude, altitude) of the evaluation target vehicle, its home location (latitude, longitude, altitude) of the drone, pilot location (latitude, longitude), direction, model name, time} to the neutralization function evaluation unit of the anti-drone evaluation server. In contrast, when receiving the target information through radar detection, the soft kill function module transmits {location (latitude, longitude, altitude), distance, direction, time} to the neutralization function evaluation unit of the anti-drone evaluation server.

The ground control station transmits {model name, location (latitude, longitude, altitude), and distance to the anti-drone product, direction, time } of the evaluation target vehicle to the neutralization function evaluation unit of the anti-drone evaluation server in real time so that the soft kill function is easily evaluated. When obtaining target information through RF detection, the ground control station additionally transmits the home location (latitude, longitude, and altitude) of the evaluation target vehicle and the location (latitude and longitude) of a pilot to the neutralization function evaluation unit.

In the case of the hard kill function, the anti-drone product transmits {destruction image of the evaluation target vehicle and time of a target} to the neutralization function evaluation unit of the anti-drone evaluation server. The neutralization function evaluation unit evaluates performance of the hard kill function through a comparison by receiving {neutralization image and time} transmitted from the neutralization photographing target vehicle. When hard kill is performed, the anti-drone evaluation server receives a neutralization image and time from the neutralization photographing target vehicle and uses the neutralization image and time as neutralization ground truth data. The determination unit within the anti-drone evaluation server performs evaluation on performance of each function by comparing and analyzing the pieces of information.

The IFF devices are mounted on the anti-drone product and the neutralization photographing target vehicle, respectively, and perform the exchange of signals. Accordingly, it is guaranteed that the anti-drone product does not attack the neutralization photographing target vehicle by mistaking the neutralization photographing target vehicle for a target.

In step S560, the anti-drone evaluation server records a pair {evaluation request contents, evaluation result} of a corresponding anti-drone product on the repository. In step S570, the anti-drone evaluation server increases the number of times that a scenario is performed. In step S580, the anti-drone evaluation server determines whether the number of times that the scenario has been performed has reached the number of scenarios generated. When determining that the number of times that the scenario has been performed is smaller than the number of scenarios generated, the anti-drone evaluation server performs evaluation based on a next scenario by repeating the process (i.e., the process of S510 to S570), and terminates the evaluation procedure when the evaluation of all of the scenarios is completed.

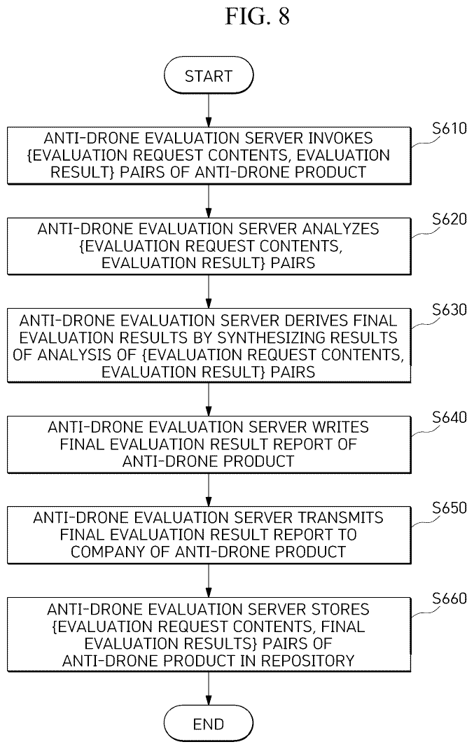

FIG. 8 illustrates the process (step S600 of the anti-drone product execution evaluation procedure illustrated in FIG. 3) of analyzing the results of evaluation after the evaluation of the anti-drone product is completed, writing the report on the final evaluation result, and transmitting the report to a company of the anti-drone product according to an embodiment of the present disclosure.

In step S610, the anti-drone evaluation server invokes {evaluation request contents, evaluation result} pairs of the anti-drone product from the repository.

In step S620, the anti-drone evaluation server confirms performance characteristics of each of the functions of the anti-drone product by analyzing the {evaluation request contents, evaluation result} pairs.

In step S630, the anti-drone evaluation server derives final evaluation results by synthesizing the results of the analysis. The derived final evaluation result may include metrics, such as the success ratios of detection, tracking, identification, and neutralization functions, a false positive rate, a false negative rate, and latency.

In step S640, the anti-drone evaluation server writes a final evaluation result report based on the final evaluation result by using the result output unit. The written final evaluation result report is generated in a document form, and may include a graph, a table, or diagram data, if necessary, so that an evaluation request company can intuitively understand performance.

In step S650, the anti-drone evaluation server transmits the final evaluation result report to a company of the anti-drone product. Accordingly, the company of the anti-drone product can objectively check actual performance of the anti-drone product and use the actual performance for the improvement of a future product and the establishment of a commercialization strategy.

In step S660, the anti-drone evaluation server stores the {evaluation request contents, final evaluation result} pairs in the repository by newly constructing the {evaluation request contents, final evaluation result} pairs. The data may be subsequently used as training data for advancing the generation of an evaluation scenario in the AI training unit.

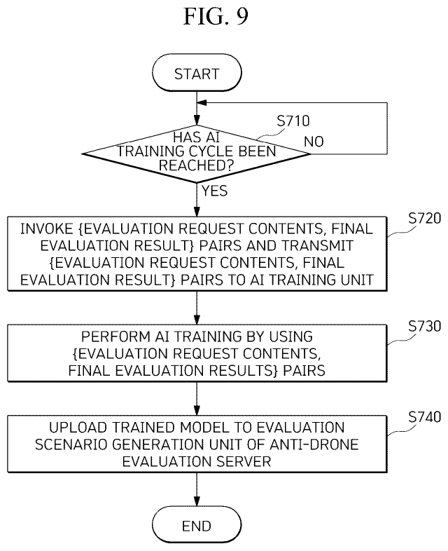

FIG. 9 illustrates the procedure (step S700 of the anti-drone product execution evaluation procedure illustrated in FIG. 3) of performing AI training on the evaluation request contents and final evaluation result of the anti-drone product after the final evaluation of the anti-drone product is terminated according to an embodiment of the present disclosure.

In step S710, the anti-drone evaluation server checks whether a pre-defined AI training cycle has been reached.

When the AI training cycle is reached, in step S720, the anti-drone evaluation server invokes {evaluation request contents, final evaluation result} pairs from the repository and transmits the {evaluation request contents, final evaluation result} pairs to the AI training unit.

In step S730, the AI training unit within the anti-drone evaluation server performs AI training by using the {evaluation request contents, final evaluation result} pairs. An object of the training is to enable the anti-drone evaluation server to secure a more sophisticated and practical evaluation scenario generation ability when receiving a new evaluation request in the future, based on various evaluation requests that were performed in the past and resulting data thereof.

In step S740, the anti-drone evaluation server uploads an AI model the training of which has been completed to the evaluation scenario generation unit. Accordingly, the anti-drone evaluation server can perform the generation of an AI-based scenario into which up-to-date evaluation results have been incorporated. As a result, an evaluation scenario has a self-evolving characteristic in which the accuracy, suitability, and reproducibility of the evaluation scenario are continuously improved.

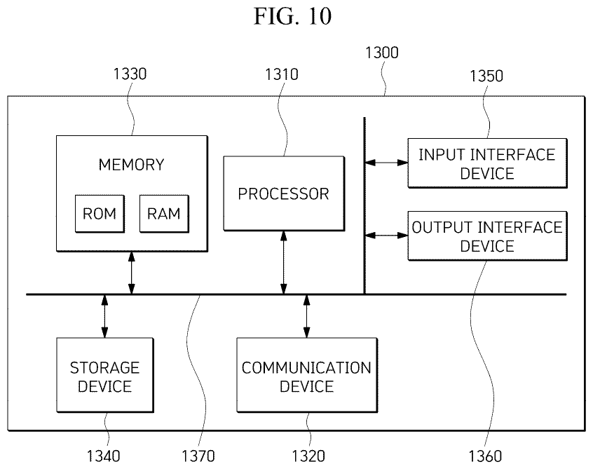

FIG. 10 is a block diagram illustrating a computer system for implementing a method according to an embodiment of the present disclosure.

Referring to FIG. 10, a computer system 1300 may include at least one of a processor 1310, memory 1330, an input interface device 1350, an output interface device 1360, and a storage device 1340, which perform communication through a bus 1370. The computer system 1300 may further include a communication device 1320 that is connected to a network. The processor 1310 may be a central processing unit (CPU) or may be a semiconductor device that executes a command stored in the memory 1330 or the storage device 1340. The memory 1330 and the storage device 1340 may include various forms of volatile or nonvolatile storage media. For example, the memory may include read only memory (ROM) and random access memory (RAM). In an embodiment of this specification, the memory may be disposed inside or outside the processor. The memory may be connected to the processor through various already-known means. The memory may be various forms of volatile or nonvolatile storage media. For example, the memory may include read-only memory (ROM) or random access memory (RAM).

Accordingly, an embodiment of the present disclosure may be implemented as a method implemented in a computer or may be implemented as a non-transitory computer-readable medium in which a computer-executable instruction has been stored. In an embodiment, when being executed by the processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. An anti-drone evaluation system comprising:
an anti-drone evaluation server configured to generate and manage an evaluation scenario of an anti-drone product;
a ground control station configured to operate in conjunction with the anti-drone evaluation server and configured to establish and transmit a flight plan of an evaluation target vehicle;
the evaluation target vehicle configured to copy an illegal drone and to fly under a control of the ground control station;
a neutralization photographing target vehicle configured to photograph a neutralization scene upon evaluation of a neutralization function; and
an anti-drone product connected to the anti-drone evaluation server and being an evaluation target.

2. The anti-drone evaluation system of claim 1, wherein the anti-drone evaluation server automatically generates the evaluation scenario by using an artificial intelligence model based on evaluation request information.

3. The anti-drone evaluation system of claim 1, wherein the ground control station generates a manual flight plan when RF detection is included in the evaluation scenario and generates an automatic flight plan when non-RF detection is included in the evaluation scenario.

4. The anti-drone evaluation system of claim 1, wherein Identification Friend or Foe (IFF) devices are connected to the neutralization photographing target vehicle and the anti-drone product, respectively, and identify the neutralization photographing target vehicle so that the anti-drone product does not mistake the neutralization photographing target vehicle for the evaluation target vehicle.

5. The anti-drone evaluation system of claim 1, wherein at least one of remote control (RC) communication having a preset band, and Wi-Fi, LTE, and 5G for a mission data exchange is used for communication between the ground control station and the evaluation target vehicle or the neutralization photographing target vehicle.

6. The anti-drone evaluation system of claim 1, wherein the anti-drone evaluation server prepares a result report after completion of the evaluation, transmits the result report to an evaluation request company, and performs training relating to a generation of a scenario by using a pair of evaluation request contents and evaluation result.

7. An anti-drone evaluation method that is performed by an anti-drone evaluation system, the anti-drone evaluation method comprising steps of:
(a) receiving an evaluation request from a company of an anti-drone product, generating an evaluation scenario, and determining the evaluation scenario through consultation with the company of the anti-drone product;
(b) transmitting the determined evaluation scenario to a ground control station and establishing a flight plan;
(c) connecting the anti-drone product, an anti-drone evaluation server, the ground control station, and an evaluation target vehicle and performing time synchronization and an interoperability test;
(d) making the evaluation target vehicle fly according to the determined evaluation scenario and performing detection, tracking, identification, and neutralization functions of the anti-drone product;
(e) receiving target information from the anti-drone product, receiving ground truth data from the ground control station, and performing evaluation on performance of the anti-drone product; and
(f) preparing a result report based on the target information and the ground truth data.

8. The anti-drone evaluation method of claim 7, wherein the evaluation scenario comprises product-related information, evaluation target vehicle-related information (comprising a number, form, size, flight pattern, and flight method of the evaluation target vehicle), evaluation items, a target information-providing source, and evaluation metrics.

9. The anti-drone evaluation method of claim 7, wherein the step (b) comprises generating an automatic or manual flight plan depending on whether RF detection is included in the evaluation scenario.

10. The anti-drone evaluation method of claim 7, wherein when hard kill is included in the evaluation scenario, the step (e) comprises receiving ground truth data for the hard kill from a neutralization photographing target vehicle.

11. The anti-drone evaluation method of claim 7, further comprising a step of (g) performing AI training relating to a generation of a scenario by using a pair of evaluation request contents and evaluation result.

12. An anti-drone evaluation server comprising:
an evaluation scenario generation unit configured to generate an evaluation scenario based on evaluation request information;
a detection function evaluation unit configured to evaluate a detection function of an anti-drone product;
a tracking function evaluation unit configured to evaluate a tracking function of the anti-drone product;
an identification function evaluation unit configured to evaluate an identification function of the anti-drone product;
a neutralization function evaluation unit configured to evaluate a neutralization function of the anti-drone product; and
a determination unit configured to write evaluation results of the anti-drone product.

13. The anti-drone evaluation server of claim 12, wherein the detection function evaluation unit receives different target information depending on radar detection or RF detection.

14. The anti-drone evaluation server of claim 12, wherein the neutralization function evaluation unit evaluates neutralization performance by comparing information received from the anti-drone product and information received from a neutralization photographing target vehicle.

15. The anti-drone evaluation server of claim 12, further comprising a repository in which evaluation request contents and evaluation result are stored.

16. The anti-drone evaluation server of claim 15, further comprising an AI training unit configured to perform a training of an artificial intelligence model for a generation of an evaluation scenario by using the evaluation request contents and the evaluation result stored in the repository.

17. The anti-drone evaluation server of claim 16, wherein the AI training unit uploads the trained artificial intelligence model to the evaluation scenario generation unit.
